(19) United States
(12) Patent Application Publication
(10) Pub. No.: US 2013/0183578 A1
(43) Pub. Date: Jul. 18, 2013

(54) POSITIVE ELECTRODE MATERIAL, A POSITIVE ELECTRODE COMPOSITION, AND A NON-AQUEOUS SECONDARY BATTERY

(71) Applicants: Masayuki Oya, Wuxi-city (JP); Mitsuhiro Kishimi, Takatsuki-city (JP)

(72) Inventors: Masayuki Oya, Wuxi-city (JP); Mitsuhiro Kishimi, Takatsuki-city (JP)

(73) Assignee: HITACHI MAXELL, LTD., Ibaraki-shi, Osaka (JP)

(21) Appl. No.: 13/823,321

(22) PCT Filed: Aug. 25, 2011
(86) PCT No.: PCT/JP2011/069121

§ 371 Date: Mar. 14, 2013

(51) Int. Cl. H01M 4/62

(52) U.S. Cl. CPC H01M 4/62
USPC 429/200; 429/213; 429/188; 252/182.1

(57) ABSTRACT

There is provided a positive electrode material used for a positive electrode of a non-aqueous secondary battery. The positive electrode material includes: a positive electrode active material; and at least one selected from the group consisting of (i) a compound having two or more epoxy groups, (ii) a ring-cleavage form of the compound in which at least one of the epoxy groups is opened, and (iii) a polymer of the compound.

### TECHNICAL FIELD

The present invention relates to a positive electrode material and a positive electrode composition for non-aqueous secondary batteries, and a non-aqueous secondary battery using such a positive electrode material or such a positive electrode composition.

### BACKGROUND TECHNOLOGY

In recent years, as there has been development in the portable electronic equipments such as cell-phones and notebook-sized personal computer or the practical use of electric cars, it has been significantly demanded to develop non-aqueous secondary batteries with high energy density. Currently, the non-aqueous secondary batteries that can meet such a demand is composed of, for example, a positive electrode using a lithium complex oxide capable of absorbing and desorbing lithium ions, and a negative electrode using lithium metal or material capable of absorbing and desorbing lithium ions, and a non-aqueous electrolyte (non-aqueous electrolyte liquid) dissolving electrolyte salts in an organic solvent.

The non-aqueous secondary batteries have problems that when stored at a high temperature, various reactions are generated between the non-aqueous electrolyte and the positive electrode active material, thereby producing gasses to cause swollenness. Lithium complex oxides such as LiCoO₂, LiNiO₂, LiMnO₂, LiMn_{1.5}Ni_{0.5}O₄ used as the positive electrode active material in the non-aqueous secondary battery is a kind of catalysts, which, therefore, react with the non-aqueous electrolyte at a high temperature to produce gasses. As a result, the gasses cause the swollenness or the capacity decrease of the batteries. Particularly, Ni (nickel) containing lithium complex oxides have recently been focused on because of a higher capacity and a large amount of elemental deposit. However, these oxides indicate a catalyst action larger than LiCoO₂ that is conventionally used, and associate with the residual alkaline components at the time of the synthesis, and therefore, gasses can be produced more.

Also, the positive electrode mixture including a lithium complex oxide with residual alkaline components, a conductive assistant and a binder is dispersed in a solvent to prepare a positive electrode composition in the form of slurry or paste, which is applied on one side or both sides of a current collector of metallic foil to dry to provide a positive electrode mixture layer. Here, the positive electrode composition tents to take a gelation form. Because of a short pot life of the positive electrode composition at the time of the production of the positive electrode, these phenomena can result in the decrease of the productivity of the positive electrodes and the non-aqueous secondary batteries.

Meanwhile, with respect to the non-aqueous secondary batteries, there have been various attempts to improve the performance by adding the additives into the non-aqueous electrolyte and the electrode at a small amount. For example, Patent References Nos. 1 and 2 propose as follows. An organic compound containing an epoxy group is added in a non-aqueous electrolyte liquid to form a good film derived from the organic compound on the negative electrode, thereby restraining a reaction between the non-aqueous electrolyte solvent and the negative electrode active material, and therefore, the charge discharge cycle characteristic of the non-aqueous secondary batteries can be found to be improved.

### PRIOR ART REFERENCES

### Patent References

Patent Reference No. 1: Japanese Laid-Open Patent Publication No. 2006-179,210
Patent Reference No. 2: Japanese Laid-Open Patent Publication No. 2009-206,081

The objectives to be solved by the invention

However, the means to improve the additives as conventionally known is not enough in solving the problems of the residual alkaline components in the positive electrode active material.

The present invention was accomplished in view of the circumstances above. Therefore, the objectives of the invention are to provide: a positive electrode material that can provide a positive electrode composition having a little aging variation during the positive electrode production and is superior in productivity; a positive electrode composition that has a little aging variation during the positive electrode production and is superior in productivity: and a non-aqueous secondary battery that is hard to cause the swollenness at a high temperature storage and superior in a storage characteristic.

### Means to solve the objectives

In view of the above, there is provided a positive electrode material used for a positive electrode of a non-aqueous secondary battery including: a positive electrode active material; and at least one of a compound having two or more epoxy groups, a ring-cleavage form of the compound in which at least one of the epoxy groups is opened, and a polymer of the compound.

Also, there is provided a positive electrode composition used for a positive electrode of a non-aqueous secondary battery, including: a positive electrode active material; a binder; at least one of a compound having two or more epoxy groups, a ring-cleavage form in which at least one of the epoxy groups of the compound is opened, and a polymer of the compound; and a solvent.

Furthermore, there is provided a non-aqueous secondary battery, including a positive electrode, a negative electrode, a separator and a non-aqueous electrolyte. Here, the positive electrode has used the positive electrode material of the above, or the positive electrode composition of the above

### Effect of the Invention

According to the present invention, there can be provided: a positive electrode material that can provide a positive electrode composition having a little aging variation during the positive electrode production and is superior in productivity; a positive electrode composition that has a little aging variation during the positive electrode production and is superior in productivity: and a non-aqueous secondary battery using the positive electrode material or the positive electrode composition, and thereby becoming hard to cause the swollenness at a high temperature storage and superior in a storage characteristic.

### BRIEF DESCRIPTION OF THE DRAWINGS

FIG. 1 shows a schematic drawing of an example of the non-aqueous secondary battery of the present invention, and FIG. 1(a) is a plan view thereof, and FIG. 1(b) is a partial longitudinal cross-sectional view.

FIG. 2 is a perspective view of FIG. 1.

### EMBODIMENTS TO CARRY OUT THE INVENTION

The positive electrode material of the present invention includes a positive electrode active material; and at least one of a compound having two or more epoxy groups, a ring-cleavage form of the compound in which at least one of the epoxy groups is opened, and a polymer of the compound.

As explained before, the positive electrode active material such as lithium complex oxide used in non-aqueous secondary batteries includes alkaline components such as LiOH, mainly, as impurities. This causes the gelation of a positive electrode composition (i.e., a composition including a solvent) used in the production of the positive electrode, or causes the swollenness of the non-aqueous secondary battery during storage (especially, in storage at a high temperature).

In this way, the positive electrode material of the present invention can be prepared by mixing a positive electrode active material with a compound having two or more epoxy groups. In coexistence with alkaline components such as LiOH, the epoxy group of this compound incorporates the alkaline components to open the ring to become ring-cleavage form, or incorporates the alkaline components to form a polymer. Therefore, the positive electrode material of the present invention can decrease the gross weight of the alkaline components included in the positive electrode active material as impurities during the steps to complete the non-aqueous secondary battery using the material (i.e., the step in preparing the positive electrode material, the step in preparing the positive electrode composition using the positive electrode material, the step in producing the positive electrode, and the step in assembling the non-aqueous secondary battery).

Thus, the positive electrode material of the present invention, if used to prepare the positive electrode composition, can control the gelation caused by the alkaline components derived from the positive electrode active material. Also, the non-aqueous secondary battery made by using the positive electrode material can restrict the generation of the swollenness caused by the alkaline components in a high temperature storage, without, e.g., causing the problematic deterioration of the charge discharge cycle characteristic.

Furthermore, the effect as explained above can be exhibited even when the charge voltage of the non-aqueous secondary battery is raised. Therefore, the positive electrode material of the present invention can be favorably used in a non-aqueous secondary battery charged with a higher voltage (e.g., 4.3-4.6V) than the normal charge voltage (4.2V).

Also, the positive electrode composition of the present invention includes, at least, a positive electrode active material; a binder; at least one of a compound having two or more epoxy groups, a ring-cleavage form in which at least one of the epoxy groups of the compound is opened, and a polymer of the compound; and a solvent. Thus, it can be used for a positive electrode of a non-aqueous secondary battery.

The positive electrode composition of the present invention can be prepared by mixing the inventive positive electrode material with other components, or by mixing the positive electrode active material with the compound having two or more epoxy groups, in the same manner as the preparation of the positive electrode material of the present invention. Here, the compound having two or more epoxy groups is used in the preparation of the positive electrode material of the present invention, or in the preparation of the positive electrode composition. With coexistence of the compound together with the alkaline components such as LiOH included in the positive electrode active material, the epoxy groups of the compound can take the alkaline components, and thereby opening the ring to provide ring-cleavage form, or causing polymerization by taking the alkaline components. Therefore, the positive electrode composition of the present invention, if used, can decrease the gross weight of the alkaline components included in the positive electrode active material as impurities in the steps of producing a non-aqueous secondary battery (i.e., the step in preparing the positive electrode composition, the step in producing the positive electrode, and the step in assembling the non-aqueous secondary battery).

Thus, the positive electrode composition of the present invention can control the gelation caused by the alkaline components derived from the positive electrode active material. Also, the non-aqueous secondary battery made by using the positive electrode composition can restrict the generation of the swollenness caused by the alkaline components in a high temperature storage without, e.g., causing the problematic decrease of the charge discharge cycle characteristic.

Furthermore, the effects as explained above can be exhibited even when raising the charge voltage of the non-aqueous secondary battery. Therefore, the positive electrode composition of the present invention can be used in a non-aqueous secondary battery charged with the voltage (e.g., 4.3-4.6V) higher than the normal charge voltage (4.2V).

As the compound having two or more epoxy groups useful for the positive electrode composition of the present invention and the positive electrode material of the present invention, the followings can be exemplified. For example, ethylene glycol diglycidyl ether, diethylene glycol diglycidyl ether, propylene glycol diglycidyl ether, tripropylene glycol diglycidyl ether, neopentyl glycol diglycidyl ether, 1,6-hexanediol diglycidyl ether, glycerin diglycidyl ether, trimethylolpropane triglycidyl ether, 1,4-cyclohexanedimethanol diglycidyl ether, 1,2:8,9 diepoxy limonene, 3,4-epoxycyclohexenylmethyl-3′,4′-epoxycyclohexene carboxylate are included. The commercial names can include EPOLIGHT Series manufactured by Kyoeisha Chemistry Co., Ltd., and CELLOXIDE Series manufactured by Daicel Corporation. The EPOLIGHT Series can include 40E, 100E, 200E, 400E, 70P, 200P, 400P, 1500NP, 1600, 80MF, 100MF, 4000, and 3002. The CELLOXIDE Series can include CELLOXIDE 2021P, and 3000.

The compound having two or more epoxy groups can be used alone or in combination of the examples listed above. Also, the compound having two or more epoxy groups can be used together with another compound having only one epoxy group.

By the action of at least one epoxy group of the compound having two or more epoxy groups in the positive electrode material and the positive electrode composition of the present invention, the ring-cleavage form or the polymer of the compound having two or more epoxy groups can be produced in the positive electrode material and the positive electrode composition of the present invention as explained before. Thus, in the positive electrode material and the positive electrode composition of the present invention, the examples of the ring-cleavage form of the compounds can include the ring-cleavage form obtained by ring-opening of at least one epoxy group of the compound having two or more epoxy groups as exemplified above; and the examples of the polymer of the compounds can include the polymer obtained by polymerizing the compound having two or more epoxy groups as exemplified above.

Also, the positive electrode material of the present invention as well as the positive electrode composition of the present invention can include at least one of the compound having two or more epoxy groups, the ring-cleavage form in which at least one epoxy group of the compound has opened its ring, and the polymer of the compound, alone or in combination of the two kinds.

The positive electrode composition of the positive electrode material of the present invention can include a positive electrode active material, which can be any positive electrode active material conventionally used in non-aqueous secondary batteries such as lithium secondary battery. In other words, it can be an active material capable of absorbing and desorbing lithium ions.

Specific examples of such a positive electrode active material can include lithium complex oxides. For example, the examples can include lithium cobalt oxide such as LiCoO₂; lithium manganese oxide such as LiMnO₂, and Li₂MnO₃; lithium complex oxide with a layer structure such as LiCo₁₋ₚNiₚO₂ (but p<0.2); lithium complex oxide with a spinel structure such as LiMn₂O₄, and Li_{4/3}Ti_{5/3}O₄; lithium complex oxide with an olivine structure such as LiFePO₄; and other oxides in which based on the oxides exemplified above, a replacement with various elements is included.

Also, the Ni-containing lithium complex oxide expressed by the following general composition formula (1) can be used as the positive electrode active material included in the positive electrode material of the present invention as well as the positive electrode composition of the present invention.

Li₁₊ₓMO₂ (1)

wherein −0.5≦x≦0.5; wherein M represents an elemental group of two or more kinds of at least one element of Mn and Co, and Ni, wherein each element constituting M meets 20≦a<100 and 50≦a+b+c≦100, in which each of a, b and c means a ratio of each of Ni, Mn and Co (mol %), respectively.

As the positive electrode active material, one kind of the lithium complex oxides as listed above can be used, or two or more kinds thereof can be used together.

Among the lithium complex oxides as listed above, the Ni-containing lithium complex oxide represented by the general composition formula (1) tends to contaminate alkaline components such as LiOH as impurities. Therefore, use of it as a positive electrode composition tends to cause the gelation. Also, the non-aqueous secondary battery using such a Ni-containing lithium complex oxide tends to cause the swollenness in e.g., high temperature storage. However, in the positive electrode material and the positive electrode composition of the present invention, the generation of the problems caused by the alkaline components can be favorably restricted even when using a Ni-containing lithium complex oxide, that is, a positive electrode active material with a large amount of the alkaline components. Thus, in present invention, when using a Ni-containing lithium complex oxide as a positive electrode active material, it is able to accomplish a high capacity of the non-aqueous secondary battery while solving the problems.

The Ni-containing lithium complex oxide represented by the general composition formula (1) includes an element group M, including at least one kind of elements selected from Mn and Co, and Ni. Here, Ni is an ingredient contributing to the capacity improvement of the Ni-containing lithium complex oxide.

In the general composition formula (1) representing the Ni-containing lithium complex oxide, it is desirable to increase the ratio of Ni as much as possible to achieve a high capacity. Thus, in the general formula (1) representing the Ni-containing lithium complex oxide, in 100 mol % of all element numbers of the element group M, the ratio “a” of Ni can be favorably 20 mol % or more, and in particular 50 mol % or more, in view of the capacity improvement of the Ni-containing lithium complex oxide. However, when the ratio of Ni is too large in the Ni-containing lithium complex oxide, Ni tends to be introduced into the Li sites to make a non-stoichiometry composition. Thus, it is favorable that the ratio “a” of Ni can be 97 mol % or less, and in particular, 90 mol % or less.

Also, when the Ni-containing lithium complex oxide includes Mn in the crystal lattice, the laminate structure can be stabilized together with the divalent state of Ni. In this way, the thermal stability of the lithium complex oxide can be improved, so that a non-aqueous secondary battery can be prepared with an improved safety.

In order to more favorably secure the effects by incorporating Mn, in the general composition formula (1) representing the Ni-containing lithium complex oxide has the following relationship. In 100 mol % of all the element number of the element group M, the ratio “b” of Mn can be favorably 1 mol % or more. However, when excess quantities of Mn exist in the Ni-containing lithium complex oxide, the elution amounts of Mn can be increased upon charge and discharge of the battery, thereby tending to deteriorate the charge discharge cycle characteristics. Therefore, the ratio “b” of Mn can be favorably 70 mol % or less.

Also, in the Ni-containing lithium complex oxide when Co exists in the crystal lattice, it can relax an irreversible reaction caused by the phase transition of the lithium complex oxide by doping and de-doping Li in charge discharge of the non-aqueous secondary battery. Thus, the reversibility of the crystal structure of the Ni-containing lithium complex oxide can be raised. Therefore, a non-aqueous secondary battery can be prepared with a long charge discharge cycle life.

In order to more favorably secure the effect by incorporating Co, there can be the relationship, as explained below, in the general composition formula (1) representing the Ni-containing lithium complex oxide. In 100 mol % of all the element numbers of the element group M, the ratio “c” of Co can be favorably 1 mol % or more. However, when excess quantities of Co are included in the Ni-containing lithium complex oxide, the elution of Co tends to decrease the charge discharge cycle characteristic and the thermal stability. Thus, the ratio “c” of Co can be favorably 50 mol % or less.

In addition, as explained below, there can be the relationship in the general composition formula (1) representing the Ni-containing lithium complex oxide. In 100 mol % of all the element numbers of the element group M, the total (a+b+c) of the ratio “a” of Ni, the ratio “b” of Mn and the ratio “c” of Co can be 50 mol % or more, and in particular, 60 mol % or more. This is achieved in view of more favorably securing the capacity.

Also, the Ni-containing lithium complex oxide can include only Ni, and Mn and/or Co as the element group M in the general composition formula (1). However, it can be further intended to improve the charge discharge cycle characteristic of the non-aqueous secondary battery using the Ni-containing lithium complex oxide and to improve the thermal stability of the Ni-containing lithium complex oxide. In this case, as elements other than Ni, Mn and Co, the Ni-containing lithium complex oxide can include e.g., at least one kind of Al, Mg, Ti, Fe, Cr, Cu, Zn, Ge, Sn, Ca, Sr, Ba, Ag, Ta, Nb, Mo, B, P, Zr, W and Ga. In this case, in the general composition formula (1) representing the Ni-containing lithium complex oxide, the total (a+b+c) of the ratio “a” of Ni, the ratio “b” of Mn and the ratio “c” of Co, can be 100 mol % or less, and in particular, e.g., 97 mol % or less, that is a value deducting the elemental contents other than Ni, Mn and Co from.

When the Ni-containing lithium complex oxide includes Al in the crystal lattice, the crystal structure of the Ni-containing lithium complex oxide can be stabilized. As a result, since the thermal stability can be improved, a non-aqueous secondary battery can be prepared with an improved safety. Also, since Al exists on the grain boundaries and the surfaces of the Ni-containing lithium complex oxide particles, the temporal stability can be improved and the side reactions with the non-aqueous electrolyte can be restricted. As a result, a non-aqueous secondary battery can be prepared with a longer life.

However, Al does not improve the charge discharge capacity. Thus, when its content in the Ni-containing lithium complex oxide is increased, the capacity may be decreased. Therefore, when Al is included in the Ni-containing lithium complex oxide, there can be the following relationship. That is, in the general composition formula (1) representing the Ni-containing lithium complex oxide, in 100 mol % of all the element numbers of the element group M, it is favorable that the ratio “d” of Al can be 10 mol % or less. In addition, to more favorably secure the effect by incorporating Al, in the general composition formula (1) representing the Ni-containing lithium complex oxide, it is favorable that the ratio “d” of Al can be 0.02 mol % or more.

When the Ni-containing lithium complex oxide includes Mg in the crystal lattice, the crystal structure of the Ni-containing lithium complex oxide can be stabilized. As a result, the thermal stability can be improved, and a non-aqueous secondary battery can be prepared with an improved safety. Also, when the lithium complex oxide causes a phase transition by doping or de-doping Li upon the charge discharge of the non-aqueous secondary battery, Mg is transferred into the Li site to relax the irreversible reaction. As a result, the reversibility of the crystal structure of the Ni-containing lithium complex oxide can be raised, and a non-aqueous secondary battery can be prepared with a long charge discharge cycle life. In particular, when the general composition formula (1) representing the Ni-containing lithium complex oxide meets x<0, the Ni-containing lithium complex oxide is in a crystal structure in a state of Li loss. In this case, the Ni-containing lithium complex oxide can be formed in which Mg is transferred into the Li site instead of Li, and therefore, a stable compound can be formed.

However, Mg contributes to a little participation in the charge discharge capacity. Thus, when its content in the Ni-containing lithium complex oxide is increased, the capacity may be decreased. Therefore, when Mg is incorporated into the Ni-containing lithium complex oxide, there can be the following relationship. That it, in the general composition formula (1) representing the Ni-containing lithium complex oxide, in 100 mol % of all the element numbers of the element group M, it is favorable that the ratio “e” of Mg can be 10 mol % or less. In addition, to more favorably secure the effect by incorporating Mg, in the general composition formula (1) representing the Ni-containing lithium complex oxide, it is favorable that the ratio “e” of Mg can be 0.02 mol % or more.

When the Ni-containing lithium complex oxide includes Ti in the particles, in a LiNiO₂ type crystal structure, it can be located in a crystalline defective part such as oxygen loss part, thereby stabilizing the crystal structure. As a result, the reversibility of the reaction of the Ni-containing lithium complex oxide can be increased, and a non-aqueous secondary battery can be constituted that is superior in the charge discharge cycle characteristics. Also, as raw material to synthesize the Ni-containing lithium complex oxides, a complex compound can be used in which Ni and Ti are uniformly mixed, and therefore, a capacity can be increased.

Therefore, when Ti is incorporated into the Ni-containing lithium complex oxide, in order to favorably secure the effect by Ti, there can be the following relationship. That is, in the general composition formula (1) representing the Ni-containing lithium complex oxide, in 100 mol % of all the element numbers of the element group M, it is favorable that the ratio “f” of Ti can be 0.01 mol % or more, and in particular, 0.1 mol % or more. Also, in the general composition formula (1) representing the Ni-containing lithium complex oxide, it is favorable that the ratio “f” of Ti can be 50 mol % or less, in particular, 10 mol % or less, and yet in particular, 5 mol % or less, and further in particular, 2 mol % or less.

In the Ni-containing lithium complex oxide, when an alkaline earth metal such as Ca, Sr and Ba is included in the particles, the growth of the primary particle can be promoted. As a result, the crystallinity of the Ni-containing lithium complex oxide can be improved, and the side reaction with the non-aqueous electrolyte can be restricted, so that the swollenness of the non-aqueous secondary battery can be further restricted in a high temperature storage. As the alkaline earth metal, Ba can be favorably used. In the general composition formula (1) representing the Ni-containing lithium complex oxide, in 100 mol % of all the element numbers of the element group M, it is favorable that the ratio “g” of the alkaline earth metal selected from Ca, Sr and Ba can be 10 mol % or less, and in particular, 5 mol % or less, and yet in particular, 3 mol % or less.

When the Ni-containing lithium complex oxide includes Fe, the crystal structure can be stabilized, and therefore, the thermal stability can be raised. Also, as raw material to synthesize the Ni-containing lithium complex oxides, by using a complex compound in which Ni and Fe are uniformly mixed, the capacity can be increased.

To favorably secure the effect by Fe, there can be the following relationship in the general composition formula (1) representing the Ni-containing lithium complex oxide. That is, in 100 mol % of all the element numbers of the element group M, it is favorable that the ratio “h” of Fe can be 0.01 mol % or more. However, when the content of Fe is increased, a divalent state of Fe tends to be generated. As a result, the capacity can be decreased, and the discharge potential can be decreased. Also, the energy density of the non-aqueous secondary battery can be decreased. Thus, in the general composition formula (1) representing the Ni-containing lithium complex oxide, it is favorable that the ratio “h” of Fe can be 50 mol % or less, and in particular, 40 mol % or less, and yet in particular, 20 mol % or less.

The Ni-containing lithium complex oxide does not need to include the element other than Ni, Mn and Co, as the element corresponding to the element group M. However, as the element other than Ni, Mn and Co, for example, one kind, or two or more kinds of the elements exemplified before can be included.

The Ni-containing lithium complex oxide having the composition as described above has a true density of 4.55-4.95 g/cm³, that is, a big value. As a result, it becomes the material having a high volume energy density. While the true density of a lithium complex oxide including Mn in a certain range is largely varied by the composition, it can be stably synthesized at the narrow composition range as described above. Thus, it is considered that such a large true density can be obtained. Also, the Ni-containing lithium complex oxide can have increased capacity per mass, so that it results in the material superior in reversibility.

The Ni-containing lithium complex oxide can have a large true density especially when the composition comes close to the stoichiometry ratio. In particular, the general composition formula (1) favorably satisfies a relation of −0.5≦x≦0.5. In adjusting the value of x in the range above, the true density and the reversibility can be increased. It is more favorable that x can be −0.1 or more, and 0.3 or less. In this case, the true density of the Ni-containing lithium complex oxide can be a higher value of 4.4 g/cm³ or more.

The Ni-containing lithium complex oxide can be composed as follows: A Li-containing compound and a Ni-containing compound, and other compounds selected from a Mn-containing compound, a Co-containing compound, an Al-containing compound, a Mg-containing compound, a Ti-containing compound, a Ba-containing and an Fe-containing compound are mixed and burned. It is noted that in order to compose a Ni-containing lithium complex oxide with higher purity, for example, it is favorable to use a complex compound containing Ni and at least one element selected from Mn, Co, Al, Mg, Ti, Fe, Cr, Cu, Zn, Ge, Sn, Ca, Sr, Ba, Ag, Ta, Nb, Mo, B, P, Zr, W and Ga (i.e., a coprecipitation compound, a compound obtained by hydrothermal synthesis, and a compound obtained by mechanical compounding, including these elements, and a compound obtained by subjecting the compounds above to a heat treatment). As such a complex compound, it is favorable to use hydroxides and oxides including the element as listed above.

In synthesis of the Ni-containing lithium complex oxide, the burning condition of the raw material mixture can be, for example, a temperature of 600-1000° C. and a period of 1-24 hours.

In the burning of the raw material mixture, rather than heating up to the predetermined temperature at a single step, the following process is favorably adopted. That is, it can be raised to a temperature lower than the burning temperature (e.g., 250-850° C.), and then, the temperature is maintained at the temperature for about 0.5 to 30 hours, and then, it is raised to the burning temperature to make the reaction proceed with. Also, it is favorable to keep a fixed concentration of the oxygen during the burning environment. As a result, the homogeneity of the composition of the Ni-containing lithium complex oxide can be favorably increased.

The atmosphere at the time of the burning of the raw material mixture can be an atmosphere including oxygen (i.e., the atmosphere), a mixture atmosphere of an inert gas (e.g., argon, helium, and nitrogen) and an oxygen gas, an oxygen gas atmosphere. Here, the oxygen concentration thereof (by volume standard) can be favorably 15% or more, and in particular, 18% or more. However, in order to reduce the production costs of the Ni-containing lithium complex oxide and thereby to improve the productivity of the non-aqueous secondary battery, it is more favorable to perform the burning of the raw material mixture in the flow of the atmosphere.

The flow quantity of the gas at the time of the burning of the raw material mixture can be favorably 2 dm³/minute or more with respect to 100 g of the mixture. When the flow quantity of the gas is too little, or when the gas speed is too slow, the homogeneity of the composition of the Ni-containing lithium complex oxide can be deteriorated. Also, the flow quantity of the gas at the time of the burning of the raw material mixture can be favorably 5 dm³/minute or less with respect to 100 g of the mixture.

In the process of the burning of the raw material mixture, a mixture made by dry blending can be used as it is. However, the following process can be favorable. That is, the raw material mixture is dispersed in a solvent such as ethanol to make it into a slurry form, and a planetary ball mill can be used to mix for e.g., 30 to 60 minutes, which can be dried to be used. Such a method can further improve the homogeneity of the Ni-containing lithium complex oxide.

In the positive electrode material of the present invention and the positive electrode composition of the present invention, the following feature can be provided. That is, when using the Ni-containing lithium complex oxide represented by the general composition formula (1) of the positive electrode active material, it can be contemplated to favorably secure the effect by the use of the compound. Thus, it is favorable that the Ni-containing lithium complex oxide represented by the general composition formula (1) can be 20 to 100 mass % in the whole quantities of the positive electrode active materials.

For example, as explained before, the positive electrode material of the present invention can be prepared by mixing the positive electrode active material with the compound having two or more epoxy groups. In the middle of such preparation, a ring-cleavage form or a polymer can be produced by the reaction of an alkaline component in the positive electrode active material with a part or the whole of the compound having two or more epoxy groups.

The mixing of the positive electrode active material with the compound having two or more epoxy groups can be carried out as follows. For example, there can be used a method for mechanically mixing the positive electrode active material with the compound having two or more epoxy groups; or a method for dissolving the compound having two or more epoxy groups to make a solution, and then spraying it on the positive electrode active material. Also, when the solution of the solvent having dissolved the compound having two or more epoxy groups is sprayed on the positive electrode active material to prepare the positive electrode composition, the following feature can be provided. That is, if necessary, a drying process can be added after having sprayed the solution on the positive electrode active material. Alternatively, the positive electrode composition can be prepared without such drying.

The solvent for dissolving the compound having two or more epoxy groups can include, water; and organic solvents such as ketones (e.g., acetone, methyl ethyl ketone, methyl isobutyl ketone), alcohols (e.g., ethanol, isopropanol), toluene, and N-methyl-2-pyrrolidone (NMP).

The positive electrode material of the present invention can be used for the preparation of the positive electrode composition of the present invention.

Namely, the positive electrode composition of the present invention at least includes: the positive electrode active material; the binder; at least one kind of the compound having two or more epoxy groups, the ring-cleavage form of the compound in which at least one epoxy group is ring-opened, and the polymers of the compound; and the solvent. The positive electrode material of the present invention can be used, as the positive electrode active material and said at least one kind of the compound having two or more epoxy groups, the ring-cleavage form of the compound in which at least one epoxy group is ring-opened, and the polymers of the compound.

Also, in the positive electrode composition of the present invention, the following process can be used to accomplish the inclusion of the positive electrode active material and said at least one kind of the compound having two or more epoxy groups, the ring-cleavage form of the compound in which at least one epoxy group is ring-opened, and the polymers of the compound. That is, the positive electrode active material and the compound having two or more epoxy groups can be used without mixing each other beforehand (i.e., without making them into a positive electrode material of the present invention).

Even when the positive electrode composition of the present invention is prepared without using the positive electrode material of the present invention, the effects as described before can be expected since the compound having two or more epoxy groups can react with the alkaline components included in the positive electrode active material. However, it will be more effective when the positive electrode composition of the present invention is prepared by using the positive electrode material of the present invention.

As to the binder used in the positive electrode composition of the present invention, either of a thermoplastic resin and a thermosetting resin can be used so long as it is chemically stable in the non-aqueous secondary battery. The specific examples of the binder can include: polyethylene, polypropylene, polytetrafluoroethylene (PTFE), PVDF, polyhexafluoropropylene (PHFP), styrene-butadiene rubber, tetrafluoroethylene-hexafluoro ethylene copolymer, tetrafluoroethylene-hexafluoropropylene copolymer (FEP), tetrafluoroethylene-perfluoroalkyl vinyl ether copolymer (PFA), vinylidenefluoride-hexafluoropropylene copolymer, vinylidenefluoride-chlorotrifluoroethylene copolymer, ethylene-tetrafluoroethylene copolymer (ETFE resin), polychlorotrifluoroethylene (PCTFE), vinylidenefluoride-pentafluoropropylene copolymer, propylene-tetrafluoroethylene copolymer, ethylene-chlorotrifluoroethylene copolymer (ECTFE), vinylidenefluoride-hexafluoropropylene-tetrafluoroethylene copolymer, vinylidenefluoride-perfluoromethylvinylether-tetrafluoroethylene copolymer or ethylene-acrylic acid copolymer, ethylene-methacrylic acid copolymer, ethylene-methylacrylate copolymer, ethylene-methylmethacrylate copolymer, and a Na ion crosslinked form of the copolymer. These compounds can be used alone or in combination thereof. Among these compounds, when the stability inside the non-aqueous secondary battery and the characteristics of the non-aqueous secondary battery are considered, a fluoric resin such as PVDF, PTFE, and PHFP can be favorable. These can be used in combination, or a copolymer formed from these monomers can be also used.

Also, the positive electrode composition of the present invention can include a conductive assistant, if necessary. As to the conductive assistant useful for the positive electrode composition of the present invention, it must be chemically stable in the non-aqueous secondary battery. The examples can include graphite such as natural graphite and artificial graphite, and carbon black such as acetylene black, ketjen black (commercial name), channel black, furnace black, lamp black, and thermal black; conductive fiber such as carbon fiber and metal fiber; metallic powder such as aluminum flakes; fluorocarbon; zinc oxide; conductive whisker such as potassium titanate; conductive metal oxides such as titanium oxide; and organic conductive material such as polyphenylene derivatives. These compounds can be used alone or in combination of two or more. Of these, it is favorable to use graphite since it is high in the conductivity and carbon black since it is superior to the liquid-absorbing property. Also, the form of the conductive assistant is not necessarily in a primary particle, but can be in aggregate such as second aggregate or in an aggregate such as chain structure. Such aggregates can be easier in handling.

Furthermore, the solvents used in the positive electrode composition of the present invention can include water and organic solvent (e.g., NMP). By using such a solvent, the positive electrode composition can be made into the form of slurry or paste. In the positive electrode composition, the binder can be dissolved in the solvent.

The positive electrode composition can be prepared as follows. There can be a method in which the positive electrode active material, the binder, the compound having two or more epoxy groups and the conductive assistant if necessary are mixed in advance (Note that instead of the positive electrode active material and the compound having two or more epoxy groups, the positive electrode material of the present invention can be used. The same is applied to the preparation of the positive electrode composition, in the description below.). Herein, the solvent is added to further mix the mixture; or a method in which the positive electrode active material, the binder, the compound having two or more epoxy groups, the conductive assistant if necessary, and the solvent are directly mixed.

Upon preparing the positive electrode material of the present invention and the positive electrode composition of the present invention, the compound having two or more epoxy groups can be included at the amount explained below. That is, it can be contemplated to favorably secure the effect by their use. Thus, in 100 parts by mass of the positive electrode active material, it is favorable to include 0.01 parts by mass or more, and in particular, 0.1 parts by mass or more. However, when including excess amounts of the compound having two or more epoxy groups in the preparation of the positive electrode material or the positive electrode composition, the amounts of the positive electrode active material can be decreased in the positive electrode mixture layer (as explained later) of the positive electrode obtained by using the positive electrode material and the positive electrode compositions. Also, when the surface of the positive electrode active material has excessively adhered to the compound, its ring-cleavage form or its polymer, the charge discharge reaction can be restricted and therefore, the capacity of the non-aqueous secondary battery can be deteriorated. Thus, upon preparing the positive electrode material of the present invention and the positive electrode composition of the present invention, it is favorable that the quantity of the compound having two or more epoxy groups can be 3 parts by mass or less, and in particular, 1 part by mass or less, with respect to 100 parts by mass of the positive electrode active material.

The quantity of the binder can be as follows. In the positive electrode mixture layer of the positive electrode obtained by using the positive electrode material of the present invention or the positive electrode composition of the present invention, it is favorable to include as little as possible so long as it can stably binds the positive electrode active material (i.e., positive electrode material) and the conductive assistant. For example, with respect to 100 parts by mass of the positive electrode active material, it is favorable to be 0.03 to 2 parts by mass. Thus, upon preparing the positive electrode composition of the present invention, it is favorable to be adjusted into the quantity range of the binder as described above.

Furthermore, the conductive assistant can be included at the amount as described below. In the positive electrode mixture layer of the positive electrode obtained by using the positive electrode material of the present invention or the positive electrode composition of the present invention, it can be included at an amount to favorably secure the conductivity and liquid-absorbing property. For example, it is favorable to be included at an amount of 0.1 to 2 parts by mass with respect to 100 parts by mass of the positive electrode active material. Thus, upon preparing the positive electrode composition of the present invention, the conductive assistant, if used, is favorable to be included at the amount as described above.

The non-aqueous secondary battery of the present invention includes a positive electrode, a negative electrode, a separator and a non-aqueous electrolyte. The positive electrode is one obtained by using the positive electrode material of the present invention or the positive electrode composition of the present invention.

For example, the positive electrode of the non-aqueous secondary battery of the present invention can include a positive electrode mixture layer formed by using the positive electrode material of the present invention or the positive electrode composition of the present invention, in which the layer is formed on one side or both sides of a current collector.

The positive electrode can be prepared as follows. For example, the positive electrode composition of the present invention is applied to a surface of a current collector and dried to form a positive electrode mixture layer. Furthermore, if necessary, press processing is given to adjust the thickness and the density of the positive electrode mixture layer. It is noted that the positive electrode of the non-aqueous secondary battery of the present invention needs to be prepared by using the positive electrode material of the present invention or the positive electrode composition of the present invention. It can be, however, prepared by using the method other than the method described above.

As the material for the current collector of the positive electrode, it is not particularly limited so long as it is chemically stable electronic conductor in the non-aqueous secondary battery. For example, the examples can include aluminum or aluminum alloy, stainless steel, nickel, titanium, carbon, and conductive resin. Another example can include a composite in which the surface of aluminum, aluminum alloy or the stainless steel has formed a carbon layer or titanium layer. Of these, aluminum or aluminum alloy is particularly preferable since it has high electric conductivity and light-weight. For example, the current collector of the positive electrode can be of the material explained above, and can be in a formed body such as foil, film, seat, net, punching sheet, lath body, porous body, foam, or fiber group. Also, a surface treatment can be applied to the surface of the current collector to give irregularities. The thickness of the current collector is not particularly limited, but can usually be 1 to 500 μm.

In applying the positive electrode composition to the surface of such a current collector, the following methods can be used: for example, there can be carried out a method to use doctor blade to take out the substrate; a coater method using e.g., die coater, comma coater, and knife coater; and a printing method such as screen print and relief print.

Also, at the time after the press processing, it is favorable that the thickness of the positive electrode mixture layer can be 15-200 μm per one side of the current collector. Furthermore, at the time after the press processing, it is favorable that the density of the positive electrode mixture layer can be 2.0 g/cm³ or more. By making the positive electrode have the positive electrode mixture layer with such a high-density, a battery can be constituted with a higher capacity. However, when the density of the positive electrode mixture layer becomes too large, the porosity becomes small, thereby causing deterioration of the permeability of the non-aqueous electrolyte. Thus, after the press processing, it is favorable that the density of the positive electrode mixture layer can be 4.5 g/cm³ or less. Also, the press processing can be performed by roll pressing at a linear pressure of e.g., 1-100 kN/cm. By such processing, a positive electrode mixture layer can be provided with such a density.

The density of the positive electrode mixture layer in this specification can be a value measured by the following method. That is, a positive electrode is cut with a predetermined area, and its mass is measured by using an electronic balance with the smallest scale of 0.1 mg. Then, the mass of the current collector is deducted therefrom to calculate the mass of the positive electrode mixture layer. On the other hand, the overall thickness of the positive electrode is measured at ten points by using a micrometer gage with the smallest scale of 1 μm. Deducting the thickness of the current collector from these values as measured, to obtain their average, which is used to calculate the volume of the positive electrode mixture layer together with the area. Then, by dividing the mass of the positive electrode mixture layer by the volume, the density of the positive electrode mixture layer is calculated.

Also, the positive electrode can be provided with a lead body to be electrically connected to other components in the battery by means of usual methods.

For example, the negative electrode of the non-aqueous secondary battery of the present invention can include a structure in which a negative electrode mixture layer including the negative electrode active material and the binder is formed on one side or both sides of a current collector.

The negative electrode active material can include: graphite (natural graphite; artificial graphite obtained from easily-graphitizable carbon, such as thermolysis graphite, mesophase carbon microbeads and carbon fibers, subjected to a graphitizing treatment at 2,800° C. or more; and etc); carbon material capable of absorbing and desorbing lithium ions, such as thermolysis carbons, cokes, glassy carbons, the burning materials form of organic polymer compounds, mesocarbon microbeadses, carbon fibers, and activated carbons; an element capable of alloying with lithium (e.g., Si, Sn, Ge, Bi, Sb, and In), and material including such an element (e.g., alloy, oxide); and lithium and lithium alloy (e.g., lithium/aluminum). In these negative electrode active materials, graphite and the element capable of alloying with lithium, or material including such an element are favorable in view of constituting a higher volume battery.

The material including the element capable of alloying with lithium can be particularly favorable to be the material including Si and O as constituent elements (note that the atom ratio of O to Si is 0.5≦y≦1.5, which hereinafter referred to as “SiO_{y}”).

SiO_{y} can include a crystallite or amorphous phase of Si. In this case, the atom ratio of O and Si can be considered as including the crystallite or amorphous phase of Si. Namely, SiO_{y} can include a structure in which Si is dispersed in amorphous SiO₂ matrix (e.g., crystallite Si), and the total of the amorphous SiO₂ and the Si dispersed therein should satisfy the atom ratio y of 0.5≦y≦1.5. For example, in the material in which Si is dispersed in an amorphous SiO₂ matrix where the molar ratio of SiO₂ and Si is 1:1, there is a relationship of y=1, thereby resulting in the structural formula of SiO. In such material, for example, an X-ray diffraction analysis cannot observe the peak from the presence of the Si (crystallite Si), but an observation by transmission electron microscope can confirm the presence of minute Si.

Also, since SiO_{y} has a low conductivity, for example, the surface of SiO_{y} can be coated with carbon, and therefore, a conductive network in the negative electrode can be more favorably provided.

The carbon for coating the surface of SiO_{y} can include, e.g., low crystalline carbon, carbon nanotube, and vapor-grown carbon fiber.

Also, there is a method [chemical vapor deposition (CVD) method] where hydrocarbon gas is heated in a vapor phase to cause thermolysis of the hydrocarbon gas to generate carbon, which is deposited on the surface of SiO_{y} particles. When coating the surface of the SiO_{y} with carbon, the hydrocarbon gas is spread out into the whole of the SiO_{y} particles, and thereby, the surface and the pores on the surface of the particles can be provided with a thin, uniform film (the carbon coating layer) including carbon having conductivity. In this way, small amounts of carbon can uniformly give good conductivity to the SiO_{y} particles.

As the liquid source of the hydrocarbon gas used in the CVD method, the examples can include toluene, benzene, xylene, and mesitylene, but toluene is particularly favorable since it is easy to handle. By vaporizing these (e.g., by bubbling with nitrogen gas), hydrocarbon gas can be generated. Also, methane gas, ethylene gas, or acetylene gas can be used.

For example, the temperature for carrying out the CVD method can be 600-1200° C. Also, the SiO_{y} provided to carry out the CVD method can be favorably in granulated form that has been granulated by known technique (i.e., composite particle).

When the SiO_{y} surface is coated with carbon, with respect to 100 parts by mass of SiO_{y}, it is favorable that the quantity of the carbon is 5 parts by mass or more, and in particular, 10 parts by mass or more; on the other hand, it is favorable that it is 95 parts by mass or lower, and in particular, 90 parts by mass or lower.

Also, SiO_{y} has a large volumetric change upon charge and discharge of the battery. Thus, the properties of a negative electrode, which contains only this compound as a negative electrode active material in a negative electrode mixture layer, tend to deteriorate because the electrode swells or shrinks during charge and discharge, so the charge-discharge cycle characteristics of the battery having such a negative electrode are likely to deteriorate. Therefore, in order to avoid such a problem, it is favorable to use a combination of SiO_{y} and graphite as the negative electrode active material. In this way, a high capacity is contemplated by the use of SiO_{y}, while restricting the swelling and shrinkage of the negative electrode upon charge and discharge of the battery, thereby maintaining improved charge-discharge cycle characteristics.

When a combination of SiO_{y} and graphite is used as the negative electrode active material, the SiO_{y} ratio in the gross quantities of the negative electrode active material can be as follows. Here, in view of favorably securing the effect of a high capacity by the use of SiO_{y}, it is favorable to be 0.5 mass % or more. Also in view of restricting the expansion and shrinkage of the negative electrode due to the SiO_{y}, it is favorable to be 10 mass % or less.

As the binder for the negative electrode mixture layer, the examples can include: fluoric resin such as PVDF and PTFE, and PHFP; synthetic rubber or natural rubber such as styrene-butadiene rubber (SBR), and nitrile rubber (NBR); celluloses such as carboxymethyl-cellulose (CMC), methyl cellulose (MC), and hydroxyethyl cellulose (HEC); acrylic acid resins such as ethylene-acrylic acid copolymer, ethylene-methacrylic acid copolymer, ethylene-methylacrylate copolymer, and ethylene-methylmethacrylate copolymer, and crosslinked form of these copolymer; amides such as polyamide, polyamide-imide, and poly-N-vinylacetamide; polyimide; polyacrylic acid; polyacrylic acid sulfonic acid; and polysaccharides such as xanthane gum, and guar gum.

Also, if necessary, the negative electrode mixture layer can include the conductive assistant as exemplified as used in the positive electrode mixture layer, as described before.

The material of the current collector of the negative electrode is not particularly limited so long as it can become an electric conductor that is chemically stable in the constructed battery. For example, the examples can include copper or copper alloy, stainless steel, nickel, titanium, carbon, and conductive resins. Other examples can include a composite in which the surface of copper, copper alloy or stainless steel has formed a carbon layer or titanium layer. Of these, because of having a high electric conductivity without alloying with lithium, it is particularly favorable to use copper or copper alloy. For example, the current collector of the negative electrode can be of the material explained above, which can be in a formed body such as foil, film, seat, net, punching sheet, lath body, porous body, foam, and fiber group. Also, a surface treatment can be applied to the surface of the current collector to give irregularities. The thickness of the current collector is not particularly limited, but can usually be 1 to 500 μm.

For example, the negative electrode can be prepared as follows. The negative electrode active material and the binder, and the conductive assistant, if necessary, are dispersed into a solvent to prepare a paste or slurry form of a negative electrode mixture (note that the binder can be dissolved in the solvent). The composition is applied to one side or both sides of a current collector, and dried to form a negative electrode mixture layer. Then, if necessary, press processing is given to adjust the thickness and the density of the negative electrode mixture layer. It is noted that the negative electrode is not limited to the manufacturing method as explained above, and other methods can be adopted. It is favorable that the thickness of the negative electrode mixture layer is 10-300 μm per one side of the current collector. Also, for example, it is favorable that the density of the negative electrode mixture layer can be 1.0-2.2 g/cm³, which can be measured by the method same as measuring the density of the positive electrode mixture layer.

It is favorable that the separator of the non-aqueous secondary battery of the present invention has the following property: At a temperature of 80° C. or more (in particular, 100° C. or more) and 180° C. or less (in particular, 150° C. or less), the separator can be provided with the property to close the pores (namely, the shut-down function). Here, a separator used in usual non-aqueous secondary batteries can be used. The examples can include fine porous membrane made of polyolefin such as polyethylene (PE) and polypropylene (PP). For example, the fine porous membrane constituting the separator can be made of PE or PP only, Also, it can be a laminate of a fine porous membrane of PE and a fine porous membrane of PP.

Also, the separator of the non-aqueous secondary battery of the present invention can be as follows. It is favorable to use a separator in a type of laminate, including a porous layer (I) mainly composed of a thermoplastic resin [in particular, a thermoplastic resin with a melting point of 80° C. or more (in particular, 100° C. or more), and 180° C. or less (in particular, 150° C. or less)]; and a porous layer (II) mainly composed of fine inorganic particles having a heat-resistant temperature of 200° C. or more. Here, in accordance with HS K 7121, the term “melting point” means a melting temperature measured by using differential scanning calorimetry (DSC). Also, “heat-resistant temperature of 200° C. or more” means that there is no transformation, such as softening, at least at a temperature of 200° C.

The porous layer (I) of the laminate type separator is contemplated to mainly secure a shut-down function. When the temperature of the non-aqueous secondary battery reaches the melting point or more of the resin mainly included in the porous layer (I), the resin in the porous layer (I) is molten to block up the pores of the separator to shut down the progress of the electrochemical reaction.

For example, the thermoplastic resin mainly composed of the porous layers (I) can include polyolefin such as PE, PP, and ethylene-propylene copolymer. As one embodiment, a dispersion liquid including particles of a thermoplastic resin such as polyolefin is applied onto the substrate such as fine porous membrane or nonwoven fabric used in the non-aqueous secondary battery, and dried. Here, in the whole volume of the components of the porous layer (I) (i.e., the whole volume excluding the pore parts), it is favorable that the volume of the main thermoplastic resin can be 50 volumes % or more, and in particular, 70 volumes % or more. It is noted that when a porous layer (I) is provided, which is, for example, of fine porous membrane made of polyolefin, the volume of the thermoplastic resin becomes 100 volumes %.

The porous layer (II) of the laminate type separator is provided with a function to prevent short circuit due to the direct contact between the positive electrode and the negative electrode even when raising the internal temperature of the non-aqueous secondary battery. This function can be accomplished by the fine inorganic particles having a heat-resistant temperature of 200° C. or more. That is, even when the temperature of the battery becomes high and the porous layer (I) is shrank, the porous layer (II) prevents the short circuit by the direct contact between the positive and negative electrodes that can be caused by the thermal shrinkage of the separator. Also, since the heat-resistant porous layer (II) acts as a framework of the separators, it can restrict the thermal shrinkage of the porous layer (I), or the overall thermal shrinkage of the separator, as well.

The fine inorganic particles of the porous layer (II) have a heat-resistant temperature of 200° C. or more, and are stable to the non-aqueous electrolyte of the battery. Furthermore, it is electrochemically stable and hard to cause redox reaction in the operating voltage of the battery. Here, it is favorable to use alumina, silica, or boehmite. Because alumina, silica, and boehmite have high oxidation resistance, and are able to adjust the particle size and the shape into the numerical values as desired. Thus, the porosity of the porous layer (II) is easy to make precise control. It is noted that the fine inorganic particles having a heat-resistant temperature of 200° C. or more can be used alone or in combination of two or more.

In the porous layer (II), the shape of the fine inorganic particles having a heat-resistant temperature of 200° C. or more is not particularly limited. It can be any shape such as almost spherical shape (including true spherical), almost oval shape (including an oval shape), and a plate-like shape.

Also, in the porous layer (II), the fine inorganic particles having a heat-resistant temperature of 200° C. or more have an average particle diameter. When the average particle diameter is too small, the permeability of ions can be decreased. Thus, it is favorable to be 0.3 μm or more, and in particular, 0.5 μm or more. Also, when the fine inorganic particles having a heat-resistant temperature of 200° C. or more are too large, the electrical characteristics tend to deteriorate.

Thus, it is favorable that the average particle diameter is 5 nm or less, and in particular, 2 nm or less. It is noted that in this specification, the average particle diameter of the fine inorganic particles means as follows. By using e.g., a laser dispersion particle size distribution meter (e.g., “LA-920” made by Horiba, Ltd.), and the fine particles are scattered to a medium to measure an average particle diameter D₅₀%.

In the porous layer (II), the fine inorganic particles having a heat-resistant temperature of 200° C. or more are included in the porous layer (II) as a main component. Thus, its quantity in the porous layers (II) can be as follows. In all volumes of the components of the porous layer (II) [i.e., the whole volume excluding the pore parts. Hereinafter, the same is applied to the quantities of the components of the porous layer (II)], it is favorable to be 50 volumes % or more, and in particular, 70 volumes % or more, and yet in particular, 80 volumes % or more, and further in particular, 90 volume % or more. That is, the fine inorganic particles can be included in the porous layer (II) at such a high amount. In this way, even when the temperature of the non-aqueous secondary battery becomes high, a thermal shrinkage of the whole separator can be favorably restricted. Thus, the generation of the short circuit due to the direct contact between the positive electrode and the negative electrode can be favorably controlled.

Also, since it is favorable to add an organic binder in the porous layer (II) as described later, the quantity of fine inorganic particles having a heat-resistant temperature of 200° C. or more in the porous layer (II) can be favorably 99.5 volumes % or less in all volumes of the components of the porous layer (II).

In the porous layer (II), in order to bind the fine inorganic particles having a heat-resistant temperature of 200° C. or more, and in order to integrate the porous layer (II) with the porous layer (I), it is favorable to include an organic binder. The organic binder can include: ethylene-vinyl acetate copolymer (EVA; e.g., one including 20-35 mol % of vinyl acetate units), ethylene-acrylic acid copolymers such as ethylene-ethylacrylate copolymer. Also, the organic binder can include fluorine-based rubber, SBR, CMC, hydroxyethyl cellulose (HEC), polyvinyl alcohol (PVA), polyvinylbutyral (PVB), polyvinylpyrrolidone (PVP), cross-linked acrylic acid resin, polyurethane, and epoxy resin. Particularly, it is favorable to use a heat-resistant binder having heat-resistant temperature more than 200° C. The organic binder can be used alone or in combination of two or more kinds.

Among the organic binders as listed above, it is particularly favorable to use a binder having high flexibility, such as EVA, ethylene-acrylic acid copolymer, fluorine-based rubber, and SBR. The examples of the organic binder having such high flexibility can include: “EVAFLEX Series” (EVA) of Du Pont-Mitsui Polychemical Co., Ltd.; EVA of Nippon Unicar Company Limited; “The EVAFLEX-EEA Series” (ethylene-acrylic acid copolymer) of Du Pont-Mitsui Polychemical Co., Ltd.; EEA of Nippon Unicar Company Limited; “The DAT-ELTM LATEX series” (fluorine-containing rubber) of Daikin Industries Ltd.; “TRD-2001” (SBR) of JSR Corporation; and “BM-400B” (SBR) of Zeon Corporation.

Also, when using the organic binder in the porous layer (II), a composition for forming the porous layer (II) as explained later can be dissolved into a solvent, or dispersed into an emulsion form.

For example, the laminate type separator can be prepared by forming the porous layer (II) on the porous layer (I) such that a composition (slurry) for porous layer (II) including the fine inorganic particles having a heat-resistant temperature of 200° C. or more is applied on the surface of the fine porous membrane to constitute the porous layer (I) and dried at a predetermined temperature.

The composition for porous layer (II) can include the fine inorganic particles having a heat-resistant temperature of 200° C. or more, along with the organic binders if necessary, which are dispersed into a solvent (i.e., including a dispersant. The same is applied to the description hereinafter.). It is noted that the organic binder can be dissolved in the solvent. The solvents used for the composition for forming the porous layer (II) is one that can disperse the fine inorganic particles uniformly, and that can dissolve or disperse the organic binder uniformly. The examples can be general organic solvents including aromatic hydrocarbons such as toluene, furans such as tetrahydrofuran, the ketones such as methyl ethyl ketone and methyl isobutyl ketone. It is noted that for the purpose of controlling the surface tension, the solvent can include an additive such as alcohols (e.g., ethylene glycol, propylene glycol), and various propylene oxide type glycol ether such as or monomethyl acetate. When an organic binder is aqueous water-soluble and used as an emulsion, the solvent can be water. In this case also, alcohols (e.g., methyl alcohol, ethyl alcohol, isopropyl alcohol, and ethylene glycol) can be added to control the surface tension.

For example, it is favorable that the composition for forming the porous layer (II) can include 10-80 mass % of a solid content including the fine inorganic particles having a heat-resistant temperature of 200° C. or more, and the organic binders.

Also, in the laminate type separator, each of the porous layer (I) and the porous layer (II) cannot be necessarily of single layer, but of plural layers to form the separator. For example, there can be a structure in which the porous layers (I) have placed on both sides of the porous layer (II), or a structure in which the porous layers (II) have placed on both sides of the porous layer (I). However, the increase of the number of the layers can increase the thickness of the separator is increased, thereby resulting in the increase of the internal resistance of the battery and the drop of the energy density. It is, thus, not favorable to increase the number of the layers excessively. Here, it is favorable that the total number of the layers, including the porous layer (I) and porous layer (II), in the laminate type separator can be five layers or less.

For example, it is favorable that the thickness of the separator of the non-aqueous secondary battery of the present invention is 10-30 μm (e.g., with respect to the separator of the fine porous membrane made of polyolefin, or the laminate type separator).

Also, in the laminate type separator, the thickness of the porous layer (II) [when the porous layer (II) is composed of a plurality of layers, it should be the total thickness] can be as follows. In view of more favorably securing each action by the porous layer (II), it is favorable to be 3 μm or more. However, when the porous layer (II) becomes too thick, there might cause a drop of the energy density of the battery. Thus, it is favorable that the thickness of the porous layer (II) is 8 μm or less.

Furthermore, in the laminate type separator, the thickness of the porous layer (I) [when the porous layer (I) is composed of a plurality of layers, the “thickness” here should be the total thickness. The same notion is applied hereinafter.] can be as follows. In view of more favorably securing the effects as explained before (in particular, the shut-down effect) by the use of the porous layer (I), it is favorable to be 6 μm or more, and in particular, 10 μm or more. However, when the porous layer (I) becomes too thick, there can cause a drop of the energy density of the battery. Also, the force to cause the thermal shrinkage of the porous layer (I) becomes too large, and the effects to suppress the thermal shrinkage of the whole of the separator can become small. Therefore, it is favorable that the thickness of the porous layer (I) is 25 μm or less, and in particular, 20 μm or less, and yet in particular, 14 μm or less.

The porosity of the whole separator is favorably 30% or more in the dry state in view of obtaining good ion permeability while maintaining a liquid-retention amount of a liquid non-aqueous electrolyte (i.e., non-aqueous electrolyte liquid). On the other hand, in order to obtain the separator strength as well as to prevent the internal short circuit, it is favorable that the porosity of the separator is 70% or less in a dry state. Here, the porosity of the separator P (%) can be calculated from the thickness of the separator, the mass per area, and the density of the components by using the formula (2) for each component i.

P={1−(m/t)/(Σai·ρi)}*100 (2)

In the formula, aᵢ is the ratio of the component i, assuming that the total mass is 1;
ρᵢ is the density (g/cm³) of component i;
m is the mass per unit area (g/cm²) of the separator; and
t is the thickness of the separator (cm).

In case of a laminate type separator, in the formula (2) above, m is assumed to be the mass per unit area (g/cm²) of the porous layer (I); and t is assumed to be the thickness (cm) of the porous layer (I). Then, the porosity P (%) of the porous layer (1) can be calculated by using formula (2) above. It is favorable that the porosity of the porous layer (1) calculated by the method is 30-70%.

Furthermore, in case of a laminate type separator, in the formula (2) above, m is assumed to be the mass per unit area (g/cm²) of the porous layer (II); and t is assumed to be the thickness (cm) of the porous layer (II). Then, the porosity P (%) of the porous layer (II) can be calculated by using the formula (2). It is favorable that the porosity of the porous layer (II) calculated by the method is 20-60%.

It is favorable that the separator has high mechanical strength, and for example, it has a piercing resistance of 3N or more. For example, when using SiO_{y} as a negative electrode active material that shows a large volumetric change in the charge and the discharge, repetition of the charge and the discharge can expand and contract the whole negative electrode, thereby resulting in the mechanical damage to the separator opposed thereto. When the piercing resistance of the separator is 3N or more, good mechanical strength is secured and the mechanical damage to the separator can be relaxed.

The separator having a piercing resistance of 3N or more can include the laminate type separator as explained before. Particularly, it is favorable to use a separator having the porous layer (I) mainly composed of the thermoplastic resin laminated on the porous layer (II) mainly composed of the fine inorganic particles having heat-resistant temperature of 200° C. or more. It has a high mechanical strength derived from the fine inorganic particles, which can supplement the mechanical strength of the porous layer (I), thereby increasing the mechanical strength of the whole separator.

The piercing resistance can be measured by the method as follows. On the board with a hole of 2 inches in diameter, a separator is fixed without forming any wrinkle or bent state. A metal pin with a tip in a semicircle spherical shape of 1.0 mm in diameter is descended toward the measuring sample at a speed of 120 mm/min to measure the power when piercing a hole on the separator five times. Then, thereby measured three, excluding the maximum and the minimum, are averaged to obtain the piercing resistance of the separator.

As the non-aqueous electrolyte of the non-aqueous secondary battery of the present invention, a solution having an electrolyte salt dissolved in an organic solvent (i.e., non-aqueous electrolyte liquid) can be used. The examples of the solvent can include aprotic organic solvents such as ethylene carbonate (EC), propylene carbonate (PC), butylene carbonate (BC), a dimethyl carbonate, diethyl carbonate (DEC), methylethyl carbonate (MEC), gamma-butyrolactone, 1,2-dimethoxyethane, tetrahydrofuran, 2-methyltetrahydrofuran, dimethyl sulfoxide, 1,3-dioxolane, formamide, dimethylformamide, dioxolane, acetonitrile, nitromethane, methyl formate, methyl acetate, trialkyl phosphate, trimethoxy methane, dioxolane derivatives, sulfolane, 3-methyl-2-oxazolidinone, propylene carbonate derivatives, tetrahydrofuran derivatives, diethyl ether, and 1,3-propane sultone. These compounds can be used alone or in combination of two or more. Also, aminimide organic solvents, or sulfur-containing or fluorine-containing organic solvents can be used, too. Among these compounds, a mixture solvent of EC, MEC and DEC is favorable. In this case, in the whole volume of the mixture solvent, it is favorable to include DEC at an amount of 15% by volume or more and 80% by volume or less. Using such a mixture solvent, the low-temperature characteristics and the charge discharge cycle characteristics of the battery can be well maintained, while improving the stability of the solvent at the time of the high voltage charge.

As the electrolyte salt of the non-aqueous electrolyte, the examples can include perchlorates of lithium, organoboron lithium salts, salts of fluorine-containing compounds such as trifluoromethanesulfonic acid salt, and an imide salt. The specific examples of such electrolyte salts can include LiClO₄, LiPF₆, LiBF₄, LiAsF₆, LiSbF₆, LiCF₃SO₃, LiC₄F₉SO₃, LiCF₃CO₂, Li₂C₂F₄ (SO₃)₂, LiN(CF₃SO₂)₂, LiC(CF₃SO₂)₃, LiC₆F₂ₙ₊₁SO₃ (n≧2), and LiN (Rf₃OSO₂)₂ [here, Rf represents a fluoroalkyl group.]. These compounds can be used alone or in combination of two or more. Among these, LiPF₆ and LiBF₄ are more favorable because of good charge discharge properties. These fluorine-containing organic lithium salts are so anionic that they are easy to be separated into ions to be dissolved in a solvent. The concentration of the electrolyte salt in the solvent is not particularly limited, but it is usually 0.5-1.7 mol/L.

For the purpose of improving the properties such as safety, charge discharge cycle property, and high temperature storability of the non-aqueous electrolyte, an additive can be appropriately added. The additive can include vinylene carbonates, 1,3-propane sultone, diphenyl disulfide, cyclohexylbenzene, biphenyl, fluorobenzene, fluoro ethylene carbonate, difluoro ethylene carbonate, t-butylbenzene, triethyl phosphate, and triethyl phosphono acetate.

For example, when vinylene carbonate is added in the non-aqueous electrolyte, it is favorable that the content of the vinylene carbonate can be at an amount of 0.01-5 mass % in the non-aqueous electrolyte to used in the battery.

Also, when the negative electrode includes a metal able to make an alloy with lithium, such as Si, SiO_{y} and Sn, it can be expected to improve the charge discharge cycle property by having the non-aqueous electrolyte adding a fluorine-containing additive such as fluoroethylene carbonate and difluoroethylene carbonate. When adding the fluorine-containing additive such as fluoroethylene carbonate and difluoroethylene carbonate to the non-aqueous electrolyte, it is favorable that the content of the fluorine-containing additive is 0.1-20 mass % in the non-aqueous electrolyte used for the battery.

For example, the non-aqueous secondary battery of the present invention can be manufactured as follows. That is, the positive electrode and the negative electrode are laminated with intervention of the separator to form a laminated electrode body, and if necessary which is further winded into a winding electrode body. Then, such an electrode body can be enclosed inside an exterior body together with the non-aqueous electrolyte to provide the battery.

Like the conventionally known non-aqueous secondary batteries, the form of the non-aqueous secondary battery can be: for example, a barrel form using an exterior can of a barrel shape (i.e., cylinder or rectangular shape); a flatten form using an exterior can of a flat shape (i.e., circle or rectangular shape in the plane view); and a soft-packaged type using an exterior can having a laminated film with a metal deposited. Also, the exterior can can be a steel can or an aluminum can.

### EXAMPLES

Hereinafter, the present invention is described in more detail based on the examples. It is, however, noted that the following examples per se should not be used to narrowly construe the present invention.

### Example 1

### <Preparation of the Positive Electrode Material>

100 parts by mass of the positive electrode active material represented by Li_{1.02}Ni_{0.6}Co_{0.2}Mn_{0.20}O₂, and 0.5 parts by mass of ethylene glycol diglycidyl ether were put into a planetary mixer, and stirred in vacuum for 30 minutes to prepare a positive electrode material.

### <Preparation of the Positive Electrode>

Into 96.8 parts by mass of the positive electrode material, 1.5 parts by mass of PVDF as a binder, and 1.7 parts by mass of acetylene black as a conductive assistant, NMP was added. Using a planetary mixer in vacuum, they were kneaded. Into this kneaded composition, NMP was further added to adjust the viscosity to thereby obtain a positive electrode composition.

The positive electrode composition was applied on both sides of an aluminum foil having a thickness of 15 μm (i.e., positive electrode current collector), and dried at 120° C. Then, a further process was applied to perform vacuum dry 12 hours at 120° C. to form a positive electrode mixture layer on both sides of the aluminum foil. Then, press work was applied to adjust the thickness and the density of the positive electrode mixture layer. Then, a lead body made of nickel was welded to an exposed part of the aluminum foil to obtain a belt-shaped positive electrode having a length of 375 mm and a width of 43 mm.

### <Preparation of the Negative Electrode>

Into 97.5 parts by mass of natural graphite with a number average particle diameter of 10 μm as a negative electrode active material, 1.5 parts by mass of styrene butadiene rubber as a binder, and 1 parts by mass of carboxymethyl cellulose as a thickener, water was added and mixed to prepare a negative electrode composition paste. This negative electrode composition paste was applied on both sides of the copper foil with a thickness of 8 μm, and had them air-dried at 100° C. Then, vacuum dry was conducted 12 hours at 120° C. to form a negative electrode mixture layer on both sides of the copper foil. Then, press work was applied to adjust the thickness and the density of the negative electrode mixture layer. Then, a lead body made by nickel was welded to an exposed part of the copper foil to obtain a belt-shaped negative electrode having a length of 380 mm and a width of 44 mm.

### <Preparation of the Non-Aqueous Electrolyte Liquid>

Into a mixture solvent of ethylene carbonate, methylethyl carbonate and diethyl carbonate at a volume ratio of 2:3:1, LiPF₆ was dissolved at a concentration of 1 mol/L. Then, 2.5 mass % of vinylene carbonate (VC) was further added to prepare a non-aqueous electrolyte liquid.

### <Assembling of the Battery>

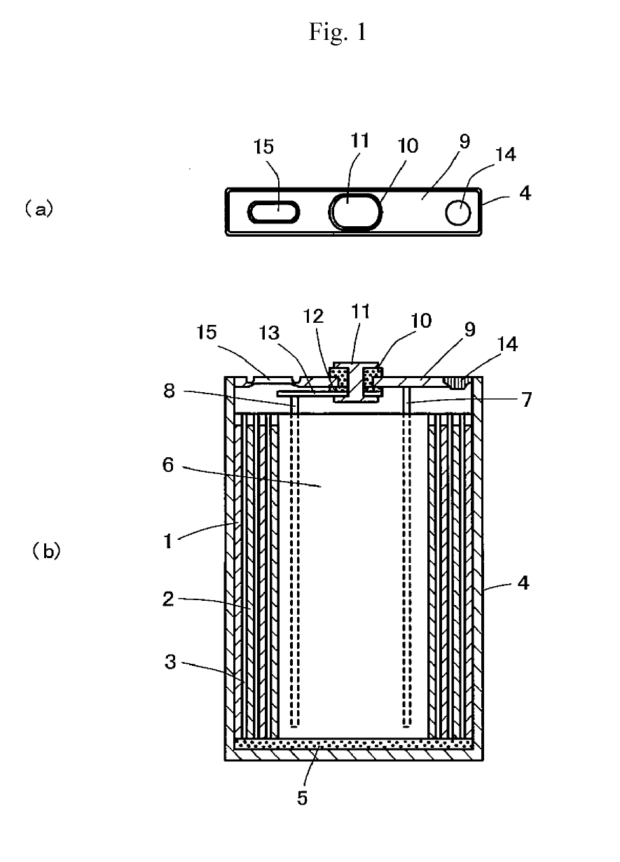

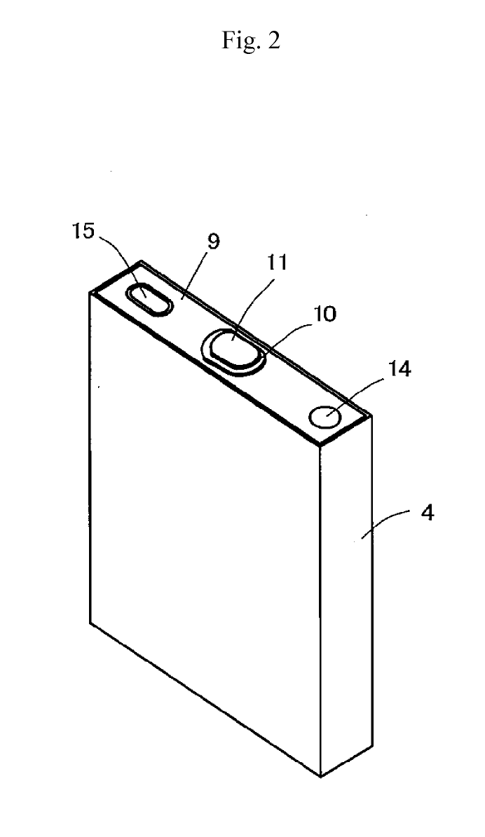

The belt-shaped positive electrode was laminated on the belt-shaped negative electrode with intervention of a microporous polyethylene separator (a porosity: 41%) having a thickness of 16 μm, and then, had them winded into a winding shape, which was then pressurized to make them a flat form to prepare a winding electrode body in a flat shape. This winding electrode body was fixed with insulating tape made of polypropylene. Then, the winding electrode body was inserted into a battery case made of aluminum alloy having a prism shape with an external size of a thickness of 4.6 mm, a width of 34 mm, and a height of 50 mm. A lead body was welded, and welded was a lid plate made by aluminum alloy to the opening end of the battery case. Then, the electrolyte was injected from an injection hole provided on the lid plate. After having kept still for one hour, the injection hole was sealed to obtain a non-aqueous secondary battery having the structure shown in FIG. 1 and an appearance shown in FIG. 2. Here, the non-aqueous secondary battery had a designed electric capacity of 900 mAh.

Here, the battery shown FIGS. 1 and 2 is explained. In FIG. 1, (a) shows a plan view, and (b) shows a partial cross-sectional view. As shown in FIG. 1(b), the positive electrode 1 and negative electrode 2 were winded via separator 3 into an spiral form, and pressed into a flat shape to form a winding electrode body 6 of a flat shape, and then, it is housed into a battery case (exterior can) in a prism shape (prism barrel shape) 4 together with a non-aqueous electrolyte liquid. However, to avoid complicatedness, FIG. 1 does not illustrate the metal foil as a current collector used in preparation of the positive electrode 1 and the negative electrode 2 as well as the non-aqueous electrolyte liquid.

The battery case 4 is made of aluminum alloy, constituting the exterior body of the battery. This battery case 4 serves as a positive terminal, too. The bottom of battery case 4 has placed an insulator 5 made of a polyethylene sheet. The positive electrode 1, negative electrode 2 and separator 3 have constituted the flat-shaped winding electrode body 6, from which a positive electrode lead body 7 and a negative electrode lead body 8 are drawn, each connected to the positive electrode 1 and the negative electrode 2. Also, the enclosing lid plate 9 is made of aluminum alloy to close the opening of the battery case 4. A terminal 11 made of stainless steel is attached via an insulating packing 10 made of polypropylene. The terminal 11 has attached to a lead board 13 made of stainless steel via an insulator 12.

Also, the lid plate 9 is inserted in the opening of the battery case 4, and their joint part is welded to each other to close the opening of the battery case 4, thereby sealing the battery inside. Also, the battery in FIG. 1 is provided with an electrolyte injection hole 14 on lid plate 9. In a state where a sealing material was inserted into the electrolyte injection hole 14, for example, welding was performed to seal by laser welding to secure the seal of the battery (therefore, in the battery of FIG. 1 and FIG. 2, although the electrolyte injection hole 14 actually includes the electrolyte injection hole and the sealing material, it is described as the electrolyte injection hole 14 for simplified explanation). Furthermore, the lid plate 9 was provided with a cleavage vent 15 serving as a mechanism to exhaust internal gas outside when increasing the temperature of the battery.

In the battery of Example 1, both of the battery case 4 and the lid plate 9 functioned as a positive terminal by directly welding the positive electrode lead body 7 to the lid plate 9. Also, the negative electrode lead body 8 was welded to the lead board 13 to have the negative electrode lead body 8 connected to the terminal 11 through the lead board 13, thereby the terminal 11 functioning as a negative electrode terminal. However, depending on materials of battery case 4, the positive or negative can be reversed.

FIG. 2 illustrates a perspective view showing the appearance of the battery shown in FIG. 1 schematically. It is noted that FIG. 2 is illustrated for the purpose to show that the battery is a prism shape battery, and FIG. 1 shows this battery schematically, so that only certain members among the battery components are shown therein. Also, FIG. 1 does not show the cross section view of the inner parts of the electrode body.

### Example 2

100 parts by mass of a positive electrode active material represented by Li_{1.02}Ni_{0.82}CO_{0.15}Al_{0.03}O₂, and 1.0 parts by mass of 3,4-epoxycyclohexenylmethyl-3′,4′-epoxycyclohexene carboxylate were put in a planetary mixer to stir in vacuum for 30 minutes to prepare a positive electrode material. Except for using this positive electrode material, the same procedure as Example 1 was performed to prepare a positive electrode. Furthermore, except for using this positive electrode, the same procedure as Example 1 was performed to prepare a non-aqueous secondary battery.

### Example 3

100 parts by mass of a positive electrode active material represented by Li_{1.00}Ni_{0.5}CO_{0.2}Mn_{0.3}O₂, and 0.5 parts by mass of diethylene glycol diglycidyl ether were put in a planetary mixer to stir in vacuum for 30 minutes to prepare a positive electrode material. Except for using this positive electrode material, the same procedure as Example 1 was performed to prepare a positive electrode.

Also, 50 parts by mass of natural graphite having a number average particle diameter of 10 μm, and 50 parts by mass of artificial graphite having a number average particle diameter of 15 μm were mixed to make a negative electrode active material. Except for using this negative electrode material, the same procedure as Example 1 was performed to prepare a negative electrode. Except for using the positive electrode and the negative electrode, the same procedure as Example 1 was performed to prepare a non-aqueous secondary battery.

### Example 4

100 parts by mass of a positive electrode active material represented by Li_{1.03}Ni_{0.9}Co_{0.05}Mn_{0.025}Mg_{0.025}O₂, and 0.7 parts by mass of neopentyl glycol diglycidyl ether were put in a planetary mixer to stir in vacuum for 30 minutes to prepare a positive electrode material. Except for using this positive electrode material, the same procedure as Example 1 was performed to prepare a positive electrode. Furthermore, except for using this positive electrode the same procedure as Example 3 was performed to prepare a non-aqueous secondary battery.

### Example 5

100 parts by mass of positive electrode active material represented by Li_{1.02}Ni_{0.34}Co_{0.34}Mn_{0.32}O₂, and 0.4 parts by mass of 1,6-hexanediol diglycidyl ether were put in a planetary mixer to stir in vacuum for 30 minutes to prepare a positive electrode material. Except for using this positive electrode material, the same procedure as Example 1 was performed to prepare a positive electrode. Furthermore, except for using this positive electrode, the same procedure as Example 3 was performed to prepare a non-aqueous secondary battery.

### Example 6

20 parts by mass of a positive electrode active material represented by Li_{1.03}Ni_{0.9}CO_{0.05}Mn_{0.025}Mg_{0.025}O₂, and 0.1 parts by mass of tripropylene glycol diglycidyl ether were put and mixed into a planetary mixer to stir in vacuum for 30 minutes. Herein, 80 parts by mass of a positive electrode active material represented by Li_{1.00}Co_{0.988}Al_{0.005}Mg_{0.005}Zr_{0.002}O₂ were added, which were put in a planetary mixer to stir in vacuum for 10 minutes to prepare a positive electrode material. Except for using this positive electrode material, the same procedure as Example 1 was performed to prepare a positive electrode.

SiO (average particle diameter 5.0 μm) was heated to about 1,000° C. in an ebullating bed reactor, such that the heated particles were contacted to a mixture gas of ethylene and nitrogen gas having a temperature of 25° C., thereby performing a CVD processing at 1,000° C. for 60 minutes. In this way, the mixture gas was pyrolized to generate carbon (hereinafter, it can be referred to as “CVD carbon”) which was deposited on the composite particle to form a coating layer, thereby obtaining a negative electrode materials (i.e., carbon-coated SiO). When calculating the composition of the negative electrode materials from the mass change before and after the formation of the coating layer, it was found to be SiO:CVD carbon=80:20 (by mass ratio).

The negative electrode active material was changed into a mixture of 49.0 parts by mass of natural graphite having a number average particle diameter of 10 μm; 49.0 parts by mass of artificial graphite having a number average particle diameter of 15 μm: and 2 parts by mass of the above carbon-coated SiO. Other than the differences above, the same procedure as Example 1 was performed to prepare a negative electrode.

Also, in a mixture solvent of ethylene carbonate, methylethyl carbonate and diethyl carbonate at a volume ratio of 2:3:1, LiPF₆ was dissolved at a concentration of 1 mol/L. Furthermore, 2.5 mass % of VC and 1 mass % of fluoroethylene carbonate (FEC) were added to prepare a non-aqueous electrolyte liquid.

Except for using the positive electrode, the negative electrode and the non-aqueous electrolyte liquid, the same procedure as Example 1 was performed to prepare a non-aqueous secondary battery.

### Example 7

100 parts by mass of a positive electrode active material represented by Li_{1.00}Ni_{0.5}Co_{0.2}Mn_{0.3}O₂, and 1.5 parts by mass of propylene glycol diglycidyl ether were put in a planetary mixer to stir in vacuum for 30 minutes to prepare a positive electrode material. Except for using this positive electrode material, the same procedure as Example 1 was performed to prepare a positive electrode. Furthermore, except for using this positive electrode, the same procedure as Example 6 was performed to prepare a non-aqueous secondary battery.

### Example 8

Into 96.8 parts by mass of a positive electrode active material represented by Li_{1.02}Ni_{0.6}Co_{0.2}Mn_{0.2}O₂, 1.5 parts by mass of PVDF as a binder, and 1.7 parts by mass of acetylene black as a conductive assistant, NMP was added. Using a planetary mixer in vacuum, they were kneaded. Herein, 0.48 parts by mass of ethylene glycol diglycidyl ether were added, and they were further kneaded. Then, NMP was further added to adjust the viscosity, thereby preparing a positive electrode composition. Except for using this positive electrode composition, the same procedure as Example 1 was performed to prepare a positive electrode. Furthermore, except for using this positive electrode, the same procedure as Example 1 was performed to prepare a non-aqueous secondary battery.

### Comparative Example 1

The positive electrode material prepared by using the positive electrode active material represented by Li_{1.02}Ni_{0.6}Co_{0.2}Mn_{0.2}O₂ and ethylene glycol diglycidyl ether was replaced with Li_{1.02}Ni_{0.6}Co_{0.2}Mn_{0.2}O₂ used as it is. Other than the differences above, the same procedure as Example 1 was performed to prepare a positive electrode. Except for using this positive electrode, the same procedure as Example 1 was performed to prepare a non-aqueous secondary battery.

### Comparative Example 2

The positive electrode material prepared by using the positive electrode active material represented by Li_{1.00}Ni_{0.5}Co_{0.2}Mn_{0.3}O₂ and diethylene glycol diglycidyl ether was replaced with Li_{1.00}Ni_{0.5}Co_{0.2}Mn_{0.3}O₂ used as it is. Other than the differences above, the same procedure as Example 3 was performed to prepare a positive electrode. Except for using this positive electrode, the same procedure as Example 3 was performed to prepare a non-aqueous secondary battery.

### Comparative Example 3

The positive electrode material prepared by using the positive electrode active material represented by Li_{1.03}Ni_{0.9}Co_{0.05}Mn_{0.025}Mg_{0.025}O₂ and neopentyl glycol diglycidyl ether was replaced with Li_{1.03}Ni_{0.9}Co_{0.05}Mn_{0.025}Mg_{0.025}O₂ used as it is. Other than the differences above, the same procedure as Example 4 was performed to prepare a positive electrode. Except for using this positive electrode, the same procedure as Example 4 was performed to prepare a non-aqueous secondary battery.

### Comparative Example 4

The positive electrode material prepared by using the positive electrode active material represented by Li_{1.03}Ni_{0.9}Co_{0.05}Mn_{0.025}Mg_{0.025}O₂, the positive electrode active material represented by Li_{1.00}Co_{0.988}Al_{0.005}Mg_{0.005}Zr_{0.002}O₂, and tripropylene glycol diglycidyl ether was replaced with a mixture of 20 parts by mass of Li_{1.03}Ni_{0.9}Co_{0.05}Mn_{0.025}Mg_{0.025}O₂; and 80 parts by mass of Li_{1.00}Co_{0.988}Al_{0.005}Mg_{0.005}Zr_{0.002}O₂. Other than the differences above, the same procedure as Example 6 was performed to prepare a positive electrode. Except for using this positive electrode, the same procedure as Example 6 was performed to prepare a non-aqueous secondary battery.

### Comparative Example 5

The positive electrode material prepared by using the positive electrode active material represented by Li_{1.00}Ni_{0.5}Co_{0.2}Mn_{0.3}O₂, and propylene glycol diglycidyl ether was replaced with Li_{1.00}Ni_{0.5}Co_{0.2}Mn_{0.3}O₂ used as it is. Other than the differences above, the same procedure as Example 7 was performed to prepare a positive electrode. Except for using this positive electrode, the same procedure as Example 7 was performed to prepare a non-aqueous secondary battery.

With respect to the non-aqueous secondary battery of Examples 1-8 and Comparative examples 1-5, the composition of the positive electrode active material used for the preparation of the positive electrode material used for the positive electrode, and the mass ratio thereof (only as for Example 6 and Comparative example 4) are shown in Table 1. Also, Table 2 shows the compound having two or more epoxy groups used for the preparation of the positive electrode material, and the use amount of the compound per 100 parts by mass of the positive electrode active material. Furthermore, Table 3 shows the negative electrode active material used for the negative electrode with respect to the non-aqueous secondary battery of Examples 1-8 and Comparative examples 1-5, and the additive used for the non-aqueous electrolyte liquid of the non-aqueous secondary battery of Examples 1-8 and Comparative examples 1-5.

TABLE 1

| | Composition and mass |
|---|---|
| | ratio of the positive electrode active material |
| Example 1 | Li_{1.02}Ni_{0.6}Co_{0.2}Mn_{0.2}O₂ |
| Example 2 | Li_{1.02}Ni_{0.82}Co_{0.15}Al_{0.03}O₂ |
| Example 3 | Li_{1.00}Ni_{0.5}Co_{0.2}Mn_{0.3}O₂ |
| Example 4 | Li_{1.03}Ni_{0.9}Co_{0.05}Mn_{0.025}Mg_{0.025}O₂ |
| Example 5 | Li_{1.02}Ni_{0.34}Co_{0.34}Mn_{0.32}O₂ |
| Example 6 | Li_{1.03}Ni_{0.9}Co_{0.05}Mn_{0.025}Mg_{0.025}O₂: 20 |
| | Li_{1.00}Co_{0.988}Al_{0.005}Mg_{0.005}Zr_{0.002}O₂: 80 |
| Example 7 | Li_{1.00}Ni_{0.5}Co_{0.2}Mn_{0.3}O₂ |
| Example 8 | Li_{1.02}Ni_{0.6}Co_{0.2}Mn_{0.2}O₂ |
| Comparative Example 1 | Li_{1.02}Ni_{0.6}Co_{0.2}Mn_{0.2}O₂ |
| Comparative Example 2 | Li_{1.00}Ni_{0.5}Co_{0.2}Mn_{0.3}O₂ |
| Comparative Example 3 | Li_{1.03}Ni_{0.9}Co_{0.05}Mn_{0.025}Mg_{0.025}O₂ |
| Comparative Example 4 | Li_{1.03}Ni_{0.9}Co_{0.05}Mn_{0.025}Mg_{0.025}O₂; 20 |
| | Li_{1.00}Co_{0.988}Al_{0.005}Mg_{0.005}Zr_{0.002}O₂: 80 |
| Comparative Example 5 | Li_{1.00}Ni_{0.5}Co_{0.2}Mn_{0.3}O₂ |

TABLE 2

| | Compound having two or more epoxy groups, | |
|---|---|---|
| | used in the positive electrode active material | |
| | or positive electrode composition | |
| | | Use amount (parts |
| | kind | by mass) |
| Example 1 | ethylene glycol diglycidyl ether | 0.5 |
| Example 2 | 3,4-epoxycyclohexenylmethyl-3′,4′- | 1.0 |
| | epoxycyclohexene carboxylate | |
| Example 3 | diethylene glycol diglycidyl ether | 0.5 |
| Example 4 | neopentyl glycol diglycidyl ether | 0.7 |
| Example 5 | 1,6-hexanediol diglycidyl ether | 0.4 |
| Example 6 | tripropylene glycol diglycidyl ether | 0.1 |
| Example 7 | propylene glycol diglycidyl ether | 1.5 |
| Example 8 | ethylene glycol diglycidyl ether | 0.5 |
| Comparative | — | — |
| Example 1 | | |
| Comparative | — | — |
| Example 2 | | |
| Comparative | — | — |
| Example 3 | | |
| Comparative | — | — |
| Example 4 | | |
| Comparative | — | — |
| Example 5 | | |

TABLE 3

| | | Additive used |
|---|---|---|
| | Negative electrode | in the non-aqueous |
| | active material | electrolyte liquid |
| Example 1 | natural graphite | VC |
| Example 2 | natural graphite | VC |
| Example 3 | natural graphite, | VC |
| | artificial graphite | |
| Example 4 | natural graphite, | VC |
| | artificial graphite | |
| Example 5 | natural graphite, | VC |
| | artificial graphite | |
| Example 6 | natural graphite, | VC, |
| | artificial graphite | FEC |
| | SiO | |
| Example 7 | natural graphite, | VC, |
| | artificial graphite | FEC |
| | SiO | |
| Example 8 | natural graphite | VC |
| Comparative Example 1 | natural graphite | VC |
| Comparative Example 2 | natural graphite, | VC |
| | artificial graphite | |
| Comparative Example 3 | natural graphite, | VC |
| | artificial graphite | |
| Comparative Example 4 | natural graphite, | VC, |
| | artificial graphite | FEC |
| | SiO | |
| Comparative Example 5 | natural graphite, | VC, |
| | artificial graphite | FEC |
| | SiO | |

Also, with respect to the non-aqueous secondary batteries of the Examples 1-8 and Comparative examples 1-5, and the positive electrode compositions used for the production of these non-aqueous secondary batteries, the following evaluations were performed. The results are shown in Table 4.

### <Capacity Measurement>

Each battery according to the Examples and the Comparative examples was stored at 60° C. for 7 hours. Then, it was subjected to a charge discharge cycle to repeat: charging at 20° C. with a current value of 200 mA for 5 hours; and discharging at a current value of 200 mA to reach a cell voltage of 2.5V. Here, the repetition was continued until the discharge capacity became steady. Then, a constant-current constant-voltage charging was conducted (constant-current: 500 mA; constant-voltage: 4.2V; and total charge time: 3 hours). After resting for one hour, it was discharged until the cell voltage reached 2.5V with a current value of 200 mA to obtain a standard capacity.

### <Storage Property>

With respect to each battery according to the Examples and the Comparative examples, constant-current constant-voltage charge (constant current: 0.4 C; constant voltage: 4.25V; total charge time: 3 hours) was conducted. Then, it was put in a constant-temperature bath and left at 80° C. for 5 days. Then, the thickness of the battery was measured. From the difference between the thickness of each battery after the storage, and the thickness before the storage (i.e., 4.6 mm), the swollenness of the battery during the storage was calculated, which was used to evaluate the storage property.

### <Stability Evaluation of the Positive Electrode Composition>

The aging variation of the viscosity was measured with respect to the positive electrode composition used for the production of each battery of the Examples and the Comparative examples. In this way, the stability of the positive electrode composition was evaluated. A cone-plate viscometer was used to perform the viscosity measurement of the positive electrode composition at a condition of 5 rpm at 25° C. The stability of each positive electrode composition was evaluated as follows: The viscosity right after the preparation thereof was compared with the viscosity after the storage at room temperature for one week with stirring by a mixture rotor. Here, the evaluation “A” was given when the viscosity of the positive electrode composition was maintained in the range of ±10% after the storage; the evaluation “B” was given when the viscosity after the storage was maintained in the range of ±20%; and the evaluation “C” was given when the viscosity after the storage had changed in the range more than 20%.

TABLE 4

| | Non-aqueous secondary battery | | |
|---|---|---|---|
| | | Swollenness | |
| | | during | |
| | Standard | storage | Stability of the positive |
| | capacity (mAh) | (mm) | electrode composition |
| Example 1 | 903 | 0.7 | B |
| Example 2 | 921 | 0.9 | B |
| Example 3 | 887 | 0.6 | B |
| Example 4 | 926 | 0.8 | B |
| Example 5 | 872 | 0.5 | A |
| Example 6 | 932 | 0.8 | A |
| Example 7 | 898 | 0.9 | B |
| Example 8 | 905 | 0.9 | B |
| Comparative | 905 | 1.3 | C |
| Example 1 | | | |
| Comparative | 890 | 1.2 | C |
| Example 2 | | | |
| Comparative | 927 | 1.7 | C |
| Example 3 | | | |
| Comparative | 934 | 1.5 | C |
| Example 4 | | | |
| Comparative | 904 | 1.6 | C |
| Example 5 | | | |

Table 4 shows as follow: The non-aqueous secondary batteries of Examples 1-7 were prepared by having the positive electrode used the positive electrode composition using the positive electrode materials in which the positive electrode material was prepared by using the positive electrode active material and the compound including two or more epoxy groups. Also, the non-aqueous secondary battery of Example 8 was prepared by having the positive electrode used the positive electrode composition prepared by using the compound including two or more epoxy groups. These Examples showed small swollenness after the storage test, resulting in the evaluation of excellent high temperature storage property. Also, the positive electrode compositions used for the production of the non-aqueous secondary batteries of Examples 1-8 were found to be excellent in the aging stability of the viscosity, suppressing the progress of the gelation. Thus, it can be concluded that the non-aqueous secondary batteries of Example 1-8 were excellent in the productivity.

In addition, the positive electrode compositions used for the production of the non-aqueous secondary batteries of Examples 5 and 6 showed more favorable results of the stability than the positive electrode compositions used to the batteries of the other Examples. This is considered because the Ni content of the positive electrode active material was fewer than the positive electrode active material used in other Examples embodiments, and also because the alkali content originally having existed was little.

The non-aqueous secondary battery of Example 8 had the constitution materials that were the same as the battery of Example 1, but the swollenness after the storage was larger than Example 1. Here, the battery of Example 8 was prepared without using the positive electrode material from the positive electrode active material and the compound having two or more epoxy groups, but it was prepared with using the positive electrode prepared from the positive electrode composition prepared by mixing the positive electrode material from the positive electrode active material and the compound having two or more epoxy groups together with other components. Thus, compared with the battery of Example 1 in which the positive electrode material prepared with the positive electrode active material and the compound having two or more epoxy groups in advance, the reaction between the alkaline components in the positive electrode active material and the compound having two or more epoxy groups was considered to be comparatively hard to proceed. Therefore, it is thought that the effect to suppress the storage swollenness was smaller.

Also, the non-aqueous secondary battery of Example 7 had slightly larger swollenness at the high temperature storage than the non-aqueous secondary battery of Example 2. These results are considered showing that the FEC added to the non-aqueous electrolyte liquid had increased the swollenness. Also, the non-aqueous secondary battery of Example 6 had slightly larger swollenness at the high temperature storage, though the positive electrode active material used had included little Ni content. This result is considered due to the same reasons as stated for the battery of Example 7.

Compared with the non-aqueous secondary batteries of the Examples, the batteries of Comparative examples 1-5 showed a larger swollenness after the storage test. These batteries are considered to have resulted in more amounts of the internal gas generation than the batteries of the Examples. Also, the positive electrode compositions used for the production of the batteries of Comparative examples 1-5 showed an increased viscosity after the storage, as shown in the stability evaluation, indicating that the gelation had progressed in a short time.

### INDUSTRIAL UTILITY

The non-aqueous secondary battery of the present invention is applicable to electric sources for various electronic equipments such as portable electronic equipment including cell-phones and notebook-sized personal computers, as well as equipments to require safety such as electric power tools, vehicles, bicycles, and power storage use.

### EXPLANATION OF THE REFERENCES IN THE DRAWINGS

1: positive electrode
2: negative electrode
3: separator

1. A positive electrode material used for a positive electrode of a non-aqueous secondary battery, comprising:
a positive electrode active material; and
at least one selected from the group consisting of (i) a compound having two or more epoxy groups, (ii) a ring-cleavage form of the compound in which at least one of the epoxy groups is opened, and (iii) a polymer of the compound.

2. The positive electrode material of claim 1, wherein the positive electrode active material is a lithium complex oxide.

3. The positive electrode material of claim 1, wherein at least a part of the positive electrode active material comprises a Ni-containing lithium complex oxide represented by a general composition formula (1),
Li₁₊ₓMO₂ (1),
wherein −0.5≦x≦0.5;
wherein M represents an elemental group of two or more kinds of at least one element of Mn and Co, and Ni,
wherein each element constituting M meets 20≦a<100 and 50≦a+b+c≦100, in which each of a, b and c means a ratio of each of Ni, Mn and Co (mol %), respectively.

4. A positive electrode composition used for a positive electrode of a non-aqueous secondary battery, comprising:
a positive electrode active material;
a binder;
at least one selected from the group consisting of (i) a compound having two or more epoxy groups, (ii) a ring-cleavage form in which at least one of the epoxy groups of the compound is opened, and (iii) a polymer of the compound; and
a solvent.

5. The positive electrode composition of claim 4, wherein the positive electrode active material is a lithium complex oxide.

6. The positive electrode composition of claim 4, wherein at least a part of the positive electrode active material comprises a Ni-containing lithium complex oxide represented by a general composition formula (1),
Li₁₊ₓMO₂ (1),
wherein −0.5≦x≦0.5;
wherein M represents an elemental group of two or more kinds of at least one element of Mn and Co, and Ni,
wherein each element constituting M meets 20≦a<100 and 50≦a+b+c≦100, in which each of a, b and c means a ratio of each of Ni, Mn and Co (mol %), respectively.

7. A non-aqueous secondary battery comprising a positive electrode, a negative electrode, a separator and a non-aqueous electrolyte,
wherein the positive electrode has used the positive electrode material of claim 1.

8. The non-aqueous secondary battery of claim 7, wherein the negative electrode comprises, as a negative electrode active material, a carbon material capable of absorbing and desorbing lithium ions, or an element or a material including the element capable of making an alloy with lithium.

9. The non-aqueous secondary battery of claim 8, wherein the negative electrode comprises, as the negative electrode active material, a material including Si and O as constituent elements (wherein an atom ratio y of O to Si is 0.5≦y≦1.5), and graphite

10. The non-aqueous electrolyte of claim 7, wherein the non-aqueous electrolyte comprises vinylene carbonate.

11. The non-aqueous secondary battery of claim 7, wherein the non-aqueous electrolyte comprises fluoroethylene carbonate.

12. A non-aqueous secondary battery comprising a positive electrode, a negative electrode, a separator and a non-aqueous electrolyte, wherein the positive electrode has used the positive electrode composition of claim 4.
